(19) United States
(12) Patent Application Publication
(10) Pub. No.: US 2014/0081688 A1
(43) Pub. Date: Mar. 20, 2014

(54) SYSTEMS AND METHODS FOR ASSIGNING ACCOUNT OWNERSHIP IN AN ON-DEMAND SYSTEM

(71) Applicant: salesforce.com inc., San Francisco, CA (US)

(72) Inventor: Jigar Kotak, San Francisco, CA (US)

(73) Assignee: salesforce.com inc., San Francisco, CA (US)

(21) Appl. No.: 13/944,685

(22) Filed: Jul. 17, 2013

Related U.S. Application Data
(60) Provisional application No. 61/701,425, filed on Sep. 14, 2012.

(51) Int. Cl. G06Q 10/06

(52) U.S. Cl. CPC G06Q 10/063112
USPC 705/7.14

(57) ABSTRACT

The technology disclosed relates to automated assignment of sales opportunities and recommendations for assignments in an on demand system. In particular, it relates to customizing assignment of sales opportunities such as leads, prospects and/or accounts to sales representatives by applying a plurality of performance indicators and ratios related to the sales representatives. These performance indicators and ratios can be based on historical and ongoing sales processes. It also relates to calculating a plurality of social insights related to the sales representatives. These social insights can be extracted from online social networks of the sales representatives.

### RELATED APPLICATION

The application claims the benefit of U.S. provisional Patent Application No. 61/701,425, entitled, “System and Method for Assigning Account Ownership in an On-Demand System,” filed on Sep. 14, 2012. The provisional application is hereby incorporated by reference for all purposes.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed inventions.

The technology disclosed relates to automated assignment of sales opportunities and recommendations for assignment in an on demand system. In particular, it relates to customizing assignment of sales opportunities such as leads, prospects and/or accounts to sales representatives by applying a plurality of performance indicators and ratios related to the sales representatives. These performance indicators and ratios can be based on historical and ongoing sales processes. It also relates to calculating a plurality of social insights related to the sales representatives. These social insights can be extracted from online social networks of the sales representatives.

Conventional enterprise management systems assign tasks based on territories. In many organizations, such assignments are manual and depend entirely on a manager's discretion. Social networking has revolutionized the way entities communicate and share information with each other. Online social environments are communities of entities that include users, groups and organizations. These entities share interests and activities and are interested in exploring the interests and activities of other entities. Many social environments provide a collection of various ways for entities to interact, such as feeds, posts, chat, messaging, email, video, voice chat, file sharing, blogging and discussion groups. Social network environments also typically provide tools and communication infrastructures for organizing and managing social networks.

As the volume of information flowing in the online social environments continues to increase, it becomes practical to apply analytics to social data. Current current enterprise management systems are typically oblivious to the power of social media, especially in the sphere of task assignment. Social data can provide authentic valuable insights that can be provide to systems for automated and superior assignment of tasks to the most-suitable candidates in terms of connectedness, influence and acquaintance.

Accordingly, it is desirable to provide systems and methods that offer a flexible approach to assignment of sales opportunities to sales representatives. An opportunity arises to override territorial assignment and use more valuable and trusted parameters that can result in efficient closing of sale opportunities. Improved entity experience and engagement and higher customer satisfaction and retention may result.

### SUMMARY

The technology disclosed relates to automated assignment of sales opportunities and recommendations for assignment in an on demand system. In particular, it relates to customizing assignment of sales opportunities such as leads, prospects and/or accounts to sales representatives by applying a plurality of performance indicators and ratios related to the sales representatives. These performance indicators and ratios can be based on historical and ongoing sales processes. It also relates to calculating a plurality of social insights related to the sales representatives. These social insights can be extracted from online social networks of the sales representatives.

### BRIEF DESCRIPTION OF THE DRAWINGS

The included drawings are for illustrative purposes and serve only to provide examples of possible structures and process operations for one or more implementations of this disclosure. These drawings in no way limit any changes in form and detail that may be made by one skilled in the art without departing from the spirit and scope of this disclosure. A more complete understanding of the subject matter may be derived by referring to the detailed description and claims when considered in conjunction with the following figures, wherein like reference numbers refer to similar elements throughout the figures.

FIG. 1 shows one implementation of an assignment environment.

FIG. 2 shows one implementation of a plurality of tables that can be used for performance based assignment.

FIG. 3 illustrates a flowchart of one implementation for performance based assignment of sales opportunities.

FIGS. 4A-4B show one implementation of a plurality of tables that can be used for insight based assignment.

FIG. 5 shows a flowchart of one implementation for insight based assignment of sales opportunities.

FIG. 6 is a block diagram of an example computer system for assigning sales opportunities in an on-demand system.

### DETAILED DESCRIPTION

The following detailed description is made with reference to the figures. Sample implementations are described to illustrate the technology disclosed, not to limit its scope, which is defined by the claims. Those of ordinary skill in the art will recognize a variety of equivalent variations on the description that follows.

The technology disclosed relates to automated assignment of sales opportunities and recommendations for assignment in an on demand system. In particular, it relates to customizing assignment of sales opportunities such as leads, prospects and/or accounts to sales representatives by applying a plurality of performance indicators and ratios related to the sales representatives. These performance indicators and ratios can be based on historical and ongoing sales processes. It also relates to calculating a plurality of social insights related to the sales representatives. These social insights can be extracted from online social networks of the sales representatives.

Examples of systems, apparatus, and methods according to the disclosed implementations are described in a “sales” context. The examples of sales opportunities such as leads, prospects and accounts are being provided to add context and aid in the understanding of the disclosed implementations. In other examples, opportunities may include product development cycles, business growth plans, etc. Other applications are possible, such that the following examples should not be taken as definitive or limiting either in scope, context or setting. It will thus be apparent to one skilled in the art that implementations may be practiced in or outside the “sales” context. The technology can be applied to selling service or selling goods, either tangible or intangible.

The technology disclosed relates to assignment of sales opportunities using a computer-implemented system. A general purpose computer system, can be used with software, a database system, a multi-tenant environment, or the like. Moreover, the described subject matter can be implemented in connection with two or more separate and distinct computer-implemented systems that cooperate and communicate with one another. This technology can be implemented in numerous ways, including as a process, an apparatus, a system, a device, a method, a computer readable medium such as a computer readable storage medium containing computer readable instructions or computer program code, or as a computer program product comprising a computer usable medium having a computer readable program code embodied therein.

The technology disclosed can effectively assign sales opportunities to sales representatives by making assignment recommendations based on a plurality of performance indicators and ratios related to the sales representatives. These indicators and ratios can be stratified into strata fields that can stratify data categorical or quantitative. Data stratification allows selection of statistics that relate more closely to a particular opportunity than general statistics can.

Performance indicators and ratios can be measured as a trend over time and can show the overall efficiency of the sales representatives. These ratios can be divided by segments, markets or any other growth area. Service providers can use these indicators and ratios to make sales forecasts and identify factors that contribute to increases in deal sizes.

The technology disclosed can also evenly distribute sales opportunities between sales representatives based on their calendar availabilities. It can monitor electronic calendars of the sales representatives and identify available slots for scheduling sales events such as sales meetings. It can further balance distribution of sales opportunities based on their workload statues by limiting the maximum number of sales opportunities that can be assigned to sales representatives considering their work functions.

The technology disclosed can also generate insights from social data and identify those sales representatives that are: most socially proximate to a lead and/or individuals working for the lead and have greatest social influence on them.

Sales representative's social proximities to individuals working for the lead can be based on shared backgrounds, common connections, connections, interactions, and engagements on online social networks such as Chatter, Facebook and LinkedIn. Social data required to drive these connection analytics can be provide from the biographical information specified in their online social networks.

Sales representatives' influence on a lead and on individuals working for the lead can be calculated based on the amount of lead related content shared by the sales representatives on online social networks. Furthermore, the number of feed items posted by other entities on sales representatives' online social networks in repose to the content posted by the sales representatives can be used as another parameter for calculating sales representatives' influence levels.

Finally, the technology disclosed can identify individuals working in sales representatives' organizations that have already established relationships with leads and competitors competing with the sales representatives' organizations. It can use sales representatives' biographical information on online social networks to identify these relationships.

### Assignment Environment

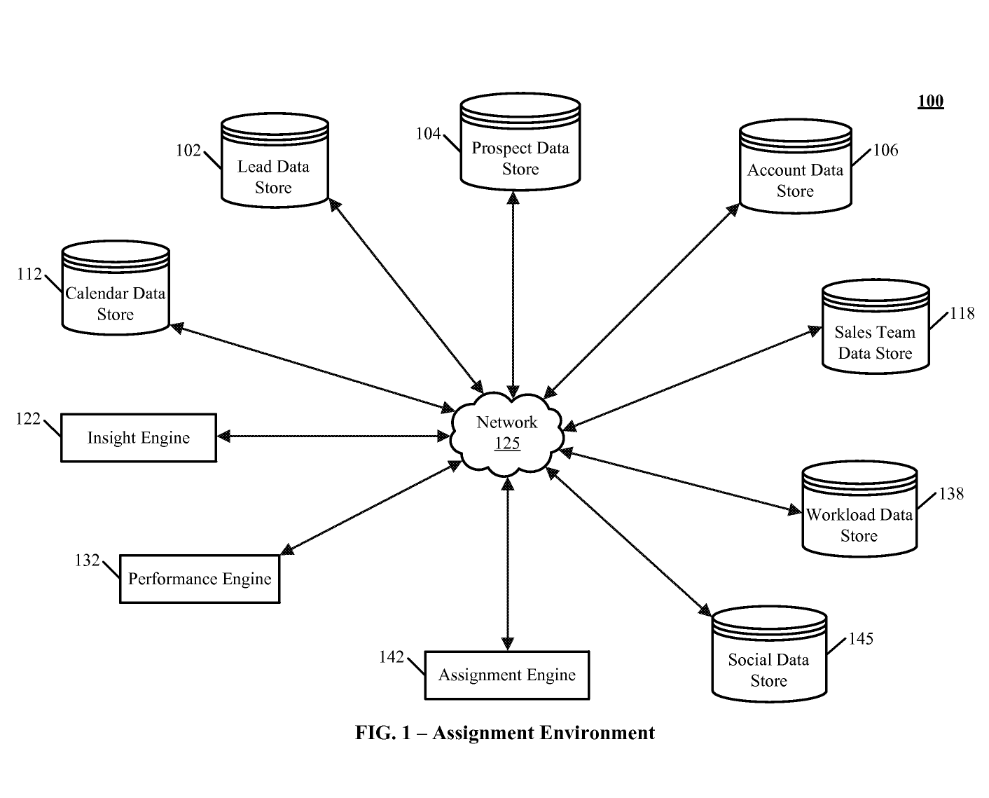

FIG. 1 illustrates one implementation of a feed customization environment 100. FIG. 1 also shows that environment 100 can include lead data store 102, prospect data store 104, account data store 106, calendar data store 112, network 125, sales team data store 118, workload data store 138, and social data store 145. FIG. 1 also includes an insight engine 122, performance engine 132 and assignment engine 142. Environment 100 may not have the same elements as those listed above and/or may have other/different elements instead of, or in addition to, those listed above. The different elements can be combined into single software modules and multiple software modules can run on the same hardware.

A “lead” refers to an entity (person or organization) that has expressed interest in a product or service of a seller or service provider. Conversely, a lead can be an entity that may not have expressed interest but appears to have a profile similar to that of seller's or service provider's target customer. In one implementation, leads can be stored in a lead data store 102. Leads can be stored based on industry type, market segment, customer segment, employee size, product line, service type, stock rate, location, and territory.

Lead data store 102 can include business-to-business data of individuals belonging to a lead along with some supplemental information. This supplemental information can be names, addresses, job titles, usernames, contact information, employer name, etc.

A “prospect” is an entity (person or organization) that has taken an affirmative action to show the intent and ability to purchase a given type of product or service. A qualification process can be used to identify prospects. The qualification process can include determining whether a lead has a need for a product or service, that lead sees value in an offering, that the lead has the financial resources for a deal, that there is access to a decision-maker, etc. In one implementation, prospects can be stored in a prospect data store 104. Prospects can be classified based on industry type, market segment, customer segment, employee size, product line, service type, stock rate, location, and territory.

Prospect data store 104 can include business-to-business data of individuals belonging to a prospect along with some supplemental information. This supplemental information can be names, addresses, job titles, usernames, contact information, employer name, etc.

An “account” is an entity (person or organization) that has contractually committed to purchase a given type of product or service. In one implementation, accounts can be stored in an account data store 106. Accounts can be classified based on revenue generated, delivery, payment, industry type, market segment, customer segment, employee size, product line, service type, stock rate, location, and territory.

Account data store 106 can include business-to-business data of individuals belonging to an account along with some supplemental information. This supplemental information can be names, addresses, job titles, usernames, contact information, employer name, etc.

Calendar data store 112, it can include a calendar populated with calendar events related to a sales representative and further include tools for managing the calendar events. Calendar data store 112 can store at least calendar entries, event subscriptions, sign-ins, and check-ins related to a sales event. It can provide specific details related to the sales event such as attendees at the sales event.

Assignment engine 142 can balance assignment of sales opportunities among a plurality of sales representatives by taking into account their calendar availabilities. In this implementation, assignment engine 142 can determine whether there is an available slot in a sales representative's calendar during a required window of time or whether the sales representative is committed to another sale opportunity based on scheduling entries made in a calendar application or service running on a user device such as a personal computer, laptop computer, tablet computer, smartphone, and the like.

Assignment engine 142 can monitor a sales representative's calendar and identify a calendar event. It can register a schedule event in memory (e.g. calendar data store 112) in response to a user selection across a user interface of a user device such as a personal computer, laptop computer, tablet computer, smartphone, etc. The schedule event can represent at least calendar entries, event subscriptions, sign-ins, and check-ins related to a sales event. In one implementation, assignment engine 142 can automatically register a check-in event in memory. It can automatically obtain check-in information for the sales representative via a smartphone or other device which includes a GPS and appropriate communications capability.

Assignment engine 142 can evenly distribute sales opportunities such as leads, prospects and/or accounts between a plurality of sales representatives by specifying the maximum amount of sales opportunities that can be assigned to a sales representative. Thus, when a sales representative reaches an upper limit of workload, he may not be assigned any new sales opportunities. The sales representative's workload record along with the upper limits can be stored in workload data store 138. In yet other implementations, the upper limits can be specific to a sales representative based on his target, goals, responsibilities, and/or functions.

Assignment engine 142 can forecast the amount of work required to cover a target sales opportunity and divide this estimate by the workload an average sales representative can handle. Such forecasts and estimates can be stored in workload data store 138. In this implementation, leads, prospects and/or accounts can be classified based on an estimate of amount of work required to service the target sales opportunity. In another implementation, this estimate can be based on past sales volumes stored in workload data store 138.

The assignment engine 142 can determine the length of various steps of a sales cycle associated with a deal and calculate the total amount of sales effort required to serve the entire market. It can then estimate the time available per sales representative and allocate the time available per sales representative based on the sales representative's responsibilities and functions. Assignment engine 142 can use the following formula to calculate the workload of a sales representative:

Workload=[Current accounts*Average time to service an active account]+[Prospects*Time spent trying to convert a prospect into an active account]+[Leads*Time spent trying to convert a lead into a prospect]

The performance engine 132 can calculate conversion ratios for the sales representatives. These conversion rates can be calculated at various steps of a sale process. For instance, a sales representatives rate of converting leads into prospects can be referred to as the “qualification rate.” This rate indicates what percentage of leads assigned to a particular sales representatives advanced into prospects. Qualification rates can be stratified by industry types, market segments, customer segments, employee sizes, product lines, service types, stock rates, locations, and territories. In one implementation, these qualification rates, mapped with the corresponding sales representatives and strata fields, can be stored in the sales team data store 118. In another implementation, performance engine 132 can use the following formula to calculate the qualification rate of a sales representative:

Qualification Rate=[Prospects/Leads]*100

In another implementation, a “closing rate” can be calculated by the performance engine 132. The closing rate can represent what percentage of prospects assigned to or advanced by a particular sales representatives got converted into accounts. Closing rates can be stratified by industry types, market segments, customer segments, employee sizes, product lines, service types, stock rates, locations, and territories. In one implementation, these closing rates can be mapped with the corresponding sales representatives and strata fields and stored in the sales team data store 118. In another implementation, performance engine 132 can use the following formula to calculate the closing rate of a sales representative:

Closing Rate=[Accounts/Prospects]*100

In one implementation, performance engine 132 can determine the average dollar amount brought in by each sales contract secured by a particular sales representative, which can referred to as “revenue conversion rate.” This rate can be normalized by eliminating very high and low values that skew the average. Revenue conversion rates can be stratified by industry types, market segments, customer segments, employee sizes, product lines, service types, stock rates, locations, and territories. In one implementation, these revenue conversion rates can be mapped with the corresponding sales representatives and strata fields and stored in the sales team data store 118. In another implementation, performance engine 132 can use the following formula to calculate the revenue conversion rate of a sales representative:

Revenue Conversion Rate=[Revenue/Accounts]

Performance engine 132 can also calculate other useful indicators and ratios such as the percentage of deals lost after responding to prospects, percentage of qualified prospects that showed no movement over a long period of time, percentage of opportunities lost without any reason for loss. These indicators and ratios can pin point where improvement is needed in a sale process and can be useful in the qualification and prioritization of sales opportunities.

Insight engine 122 can crawl the network 125 to find information related to a lead, prospect and/or account (e.g., a company, firm or organization). The found recent new information related to the company can be stored in social data store 145. Social data store 145 can be populated by the insight engine 122 to include standard profile information about the lead, prospect and/or account. This standard profile information can be extracted from company websites, business registration sources such as Hoovers or D&B, business intelligence sources, and/or social networking websites like Yelp, Yellow Pages, etc.

Insight engine 122 can spider various person-related data sources such as access controlled application-programming interfaces (APIs), public internet and social networking sites to find any online social connections and shared backgrounds between sales representatives and individuals belonging to lead, prospects and/or accounts. The retrieved social connections can be stored in the social data store 145.

Regarding different types of person-related data sources, APIs like Yahoo Boss, Facebook Open Graph, Twitter Firehose can provide real-time search data aggregated from numerous social media sources such as Yahoo, Facebook and Twitter. These APIs can initialize sorting, processing and normalization of person-related data. Public Internet can provide person-related data from public sources such as first hand websites, blogs, web search aggregators, and social media aggregators. Social networking sites can provide person-related data from social media sources such as Twitter, Facebook, LinkedIn, and Klout.

The social data store 145 can include social media content like social media sources, social accounts, social personas, social profiles, social handles, content shared, feed items, posts, etc. Social media content can add social context to the business-to-business contacts held in lead data store 102, prospect data store 104 and account data store 106. Conversely, business-to-business contacts can add business context to the social personas or profiles according to some other implementations.

Social data store 145 can include a user profile that includes data about the user of a database system. The data can include general information, such as title, phone number, a photo, and biographical summary. The data can include messages created by other users.

Social data store 145 can include a feed that is a combination (e.g. a list) of feed items. A feed item or feed element can include information about a user of the database referred to as profile feed or about a record referred to as record feed. A user following the user or record can receive the associated feed items. The feed items from all of the followed users and records can be combined into a single feed for the user.

An information feed in the context of a social network is a collection of information selected from the social network for presentation in a user interface. The information presented in the information feed can include entries posted to a user's wall or any other type of information accessible within the social network. For example, a user's news feed can include text inputs such as comments (e.g., statements, questions, emotional expressions), responses to comments (e.g., answers, reactionary emotional expressions), indications of personal preferences, status updates, and hyperlinks. As another example, a news feed can include file uploads, such as presentations, documents, multimedia files, and the like.

A feed item can be a message, post, update stream, and/or a story (also called a feed tracked change). A feed can be a combination of messages and stories. Messages can include text created by a user, and other data as well. Examples of messages include posts, status updates, likes, replies, shares, and comments. Messages can be created for a user's profile or for a record. Posts can be created by various users, potentially any user, although some restrictions can be applied. As an example, posts can be made to a wall section of a user's profile (which can include a number of recent posts) or a section of a record that includes multiple posts. The posts can be organized in chronological order.

In contrast to a post, a status update changes a status of a user and is made by that user. Other similar sections of a user's profile can also include an “About” section. A record can also have a status, whose update can be restricted to the owner of the record.

The owner can be a single user, multiple users, or a group. In some implementations, there is only one status for a record.

A comment can be made on any feed item. In another implementation, comments can be organized as a list explicitly tied to a particular story, post, or status update. In this implementation, comments may not be listed in the first layer (in a hierarchal sense) of feed items, but listed as a second layer branching from a particular first layer feed item.

Social data store 145 can include a story, which is data representing an event, and can include text generated by the database system in response to the event. In one implementation, the data can initially be stored, and then the database system can later use the data to create text for describing the event. Both the data and/or the text can be a story.

Social data store 145 can include a group, which is a collection of users. The group can be defined as users with a same or similar attribute, or by membership. In one implementation, a group feed can include any feed item about any user in a group. In another implementation, a group feed can include feed items that are about the group as a whole. In one implementation, the feed items for a group are only posts and comments.

Social data store 145 can include an entity feed or record feed that refers to a feed of feed items about a particular record in the database, such as stories about changes to the record and posts made by users about the record. An entity feed can be composed of any type of feed item. Such a feed can be displayed on a page (e.g. a web page) associated with the record (e.g. a home page of the record). In other implementations, a profile feed is a feed of feed items about a particular user.

In one implementation, the feed items for a profile feed can be posts and comments that other users make about or send to the particular user, and status updates made by the user. Such a profile feed can be displayed on a page associated with the particular user. In another implementation, feed items in a profile feed can include posts made by the particular user and feed tracked changes (stories) initiated based on actions of the particular user.

In one implementation, a user can make a comment within a user's news feed. Such a comment can propagate to the appropriate profile feed or record feed, and then to the news feeds of the following users. Thus, feeds can include what people are saying, as well as what they are doing. In one aspect, feeds are a way to stay up-to-date (e.g., on users, opportunities, etc.) as well as an opportunity to reach out to co-workers/partners and engage them around common goals.

A feed item can include one or more actionable selections configured to interact with the record. The one or more actionable selections can be actionable buttons providing a reference to the publisher. Selecting one of the actionable selections can cause the publisher to be operable to receive information associated with the record for record updates. For instance, if the record is a case, one of the actionable selections can enable the user to send an email to resolve the case via the publisher.

### Performance Based Assignment Records

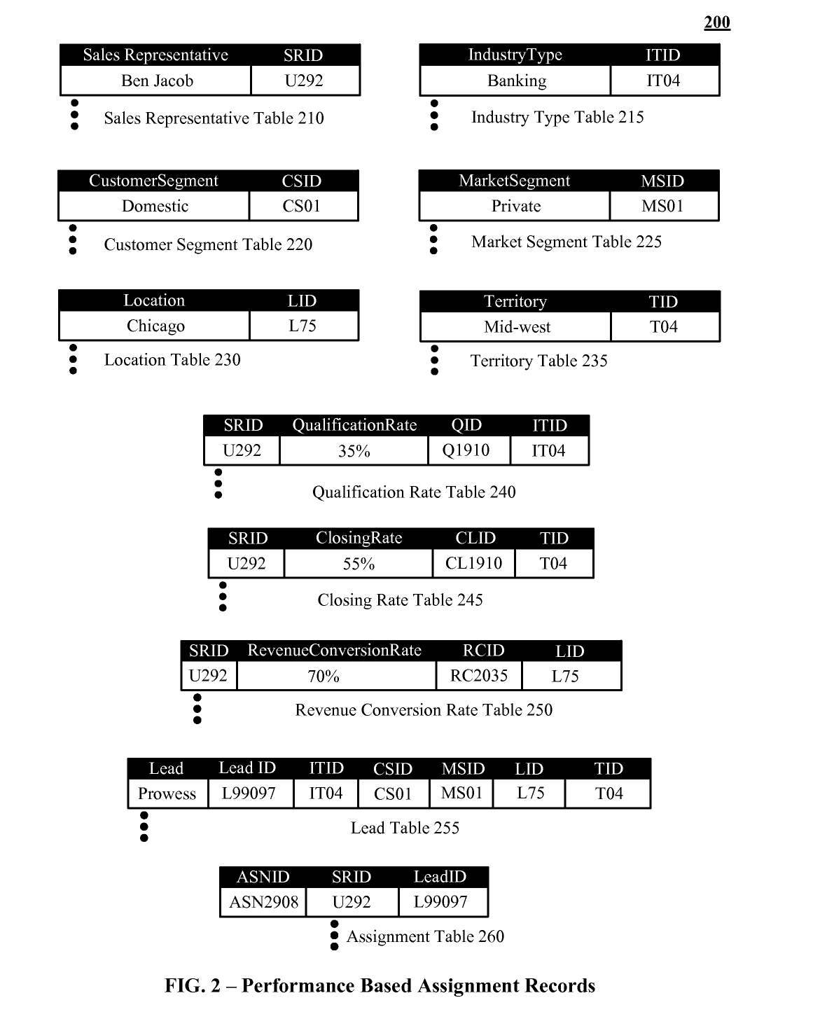

FIG. 2 shows one implementation 200 of a plurality of tables that can be used for performance based assignment. As described above, this and other data structure descriptions that are expressed in terms of tables also can be implemented as objects or in tables that store multiple record or object types. Reference to tables is for convenience of explanation and not as a limitation on the data structure implementation. FIG. 2 shows a sales representative table 210, industry type table 215, customer segment table 220, market segment table 225, location table 230, and territory table 235. FIG. 2 can include a qualification rate table 240, closing rate table 245, revenue conversion rate table 250, and assignment table 260. In other implementations, implementation 200 may not have the same tables, entries or fields as those listed above and/or may have other/different tables, entries or fields instead of, or in addition to, those listed above.

Sales representative table 210 can provide a list of sales representatives working for a service provider. It can include columns that specify names of sales representatives along with their sales representative IDs referred to as “SRID.” As shown in FIG. 2, table 210 can uniquely identify a sales representative with the name “Ben Jacob” and assign him a SRID of “U292.”

Sales representative table 210 can have one or more of the following variables with certain attributes: USER_ID being CHAR (15 BYTE), ORGANIZATION_ID being CHAR (15 BYTE), DEPARTMENT_ID being CHAR (15 BYTE), CREATED_BY being CHAR (15 BYTE), CREATED_DATE being DATE, and DELETED being CHAR (1 BYTE).

New entries can be added chronologically with a new record ID, which can be incremented in order. The first key prefix can provide a key that is unique to a group of records, e.g., custom records (objects). The “organization” variable can provide an ID of an organization to which the record is related. The “created by” variable can track the user who is performing the action that results in the record. The “created date” variable can specify the time stamp of record creation. The deleted variable can indicate that the record was deleted, and thus the record is not generated.

Industry type table 215 can provide a list of various industry types into which sales opportunities can be stratified. Examples of industry types can include banking, technology, entertainment, sports, legal, real estate, etc. Industry table 215 can include columns that specify names of industry types along with their industry type IDs referred to as “ITID.” As shown in FIG. 2, table 215 can uniquely identify a “Banking” industry type and assign it an ITID of “IT04.”

Industry type table 215 can have one or more of the following variables with certain attributes: TYPE_ID being CHAR (15 BYTE), ORGANIZATION_ID being CHAR (15 BYTE), SECTOR_ID being CHAR (15 BYTE), CREATED_BY being CHAR (15 BYTE), CREATED_DATE being DATE, and DELETED being CHAR (1 BYTE).

Customer segment table 220 can provide a list of various customer segments into which sales opportunities can be stratified. Examples of industry types can include domestic, international, regional, local, sectorial, etc. Customer segment table 220 can include columns that specify names of customer segments along with their customer segment IDs referred to as “CSID.” As shown in FIG. 2, table 220 can uniquely identify a “Domestic” customer segment and assign it a CSID of “CS01.”

Customer segment table 220 can have one or more of the following variables with certain attributes: SEGMENT_ID being CHAR (15 BYTE), ORGANIZATION_ID being CHAR (15 BYTE), LOCATION_ID being CHAR (15 BYTE), CREATED_BY being CHAR (15 BYTE), CREATED_DATE being DATE, and DELETED being CHAR (1 BYTE).

Market segment table 225 can provide a list of various market segments into which sales opportunities can be stratified. Examples of market segments can include private, public, global, etc. Market segment table 225 can include columns that specify names of market segments along with their market segment IDs referred to as “MSID.” As shown in FIG. 2, table 225 can uniquely identify a “Private” market segment and assign it a MSID of “MS01.”

Market segment table 225 can have one or more of the following variables with certain attributes: SEGMENT_ID being CHAR (15 BYTE), ORGANIZATION_ID being CHAR (15 BYTE), BASE_ID being CHAR (15 BYTE), CREATED_BY being CHAR (15 BYTE), CREATED_DATE being DATE, and DELETED being CHAR (1 BYTE).

Location table 230 can provide a list of various locations into which sales opportunities can be stratified. Examples of locations can include Chicago, San Francisco, New York, etc. Location table 230 can include columns that specify names of locations along with their location IDs referred to as “LID.” As shown in FIG. 2, table 230 can uniquely identify a location to be “Chicago” and assign it a LID of “L75.”

Location table 230 can have one or more of the following variables with certain attributes: ZIPCODE_ID being CHAR (15 BYTE), COUNTRY_ID being CHAR (15 BYTE), STATE_ID being CHAR (15 BYTE), CREATED_BY being CHAR (15 BYTE), CREATED_DATE being DATE, and DELETED being CHAR (1 BYTE).

Territory table 235 can provide a list of various territories into which sales opportunities can be stratified. Examples of territories can include Mid-west, East coast, West coast, etc. Territory table 235 can include columns that specify names of territories along with their territory IDs referred to as “TID.” As shown in FIG. 2, table 235 can uniquely identify a territory as “Midwest” and assign it a TID of “T04.”

Territory table 235 can have one or more of the following variables with certain attributes: ZIPCODE_ID being CHAR (15 BYTE), COUNTRY_ID being CHAR (15 BYTE), STATE_ID being CHAR (15 BYTE), CREATED_BY being CHAR (15 BYTE), CREATED_DATE being DATE, and DELETED being CHAR (1 BYTE).

Qualification rate table 240 can specify qualification rates of various sales representatives. Qualification rate table 240 can specify these qualification rates based on strata fields such as industry types, market segments, customer segments, employee sizes, product lines, service types, stock rates, locations, and territories. In one implementation, qualification rate table 240 can include columns that specify qualification rates as percentages along with their qualification IDs referred to as “QID.” As shown in FIG. 2, table 240 can uniquely identify qualification rate of sales representative named Ben Jacob (SRID being U292) for banking industry (ITID being IT04). In another implementation, this qualification rate can be assigned a QID of “Q1910” and have a value entry of “35%.”

Qualification rate table 240 can have one or more of the following variables with certain attributes: USER_ID being CHAR (15 BYTE), ORGANIZATION_ID being CHAR (15 BYTE), SECTOR_ID being CHAR (15 BYTE), CREATED_BY being CHAR (15 BYTE), CREATED_DATE being DATE, and DELETED being CHAR (1 BYTE).

Closing rate table 245 can specify closing rates of various sales representatives. Closing rate table 245 can specify these closing rates based on strata fields such as types, market segments, customer segments, employee sizes, product lines, service types, stock rates, locations, and territories. In one implementation, closing rate table 245 can include columns that specify closing rates as percentages along with their closing IDs referred to as “CLID.” As shown in FIG. 2, table 245 can uniquely identify closing rate of sales representative named Ben Jacob (SRID being U292) for mid-west territory (TID being T04). In another implementation, this closing rate can be assigned a CLID of “CL1910” and have a value entry of “55%.”

Closing rate table 245 can have one or more of the following variables with certain attributes: USER_ID being CHAR (15 BYTE), ORGANIZATION_ID being CHAR (15 BYTE), SECTOR_ID being CHAR (15 BYTE), CREATED_BY being CHAR (15 BYTE), CREATED_DATE being DATE, and DELETED being CHAR (1 BYTE).

Revenue conversion rate table 250 can specify revenue conversion rates of various sales representatives. Revenue conversion rate table 250 can specify these revenue conversion rates based on strata fields such as types, market segments, customer segments, employee sizes, product lines, service types, stock rates, locations, and territories. In one implementation, revenue conversion rate table 250 can include columns that specify revenue conversion rates as percentages along with their revenue conversion IDs referred to as “RCID.” As shown in FIG. 2, table 250 can uniquely identify revenue conversion rate of sales representative named Ben Jacob (SRID being U292) for Chicago (LID being L75). In another implementation, this revenue conversion rate can be assigned a RCID of “RC2035” and have a value entry of “70%.”

Revenue conversion rate table 250 can have one or more of the following variables with certain attributes: USER_ID being CHAR (15 BYTE), ORGANIZATION_ID being CHAR (15 BYTE), SECTOR_ID being CHAR (15 BYTE), CREATED_BY being CHAR (15 BYTE), CREATED_DATE being DATE, and DELETED being CHAR (1 BYTE).

Lead table 255 can provide a list of leads that represent interests of organizations in products or services of a service provider. Lead table 255 can specify various attributes of a lead such its industry type, market segment, customer segment, employee size, product line, service type, stock rate, location, and territory. In one implementation, lead table 255 can include columns that specify names of leads along with their lead IDs referred to as “LeadID.” As shown in FIG. 2, table 255 can uniquely identify a lead as “Prowess” and assign it a LeadID of “L99097.” In another implementation, lead table 255 can identify various lead attributes like industry type, customer segment, market segment, location, and territory using their respective IDs: IT04, CS01, MS01, L75, and T04.

Lead table 255 can have one or more of the following variables with certain attributes: ORGANIZATION_ID being CHAR (15 BYTE), SALES_REPRESENTATIVE_ID being CHAR (15 BYTE), CONTACT_ID being CHAR (15 BYTE), CREATED_BY being CHAR (15 BYTE), CREATED_DATE being DATE, and DELETED being CHAR (1 BYTE). Prospects and accounts tables that include various prospects and accounts attributes can also be specified.

Assignment engine 142 can identify characteristics of a lead to find sales representatives who are successful with accounts that share the same lead characteristics. This can be understood by reference to an example. Suppose the lead is a banking company in Chicago. In one implementation, characteristics of the lead can be: “industry type=banking” and “location=Chicago.” The assignment engine 142 can then find those sales representatives that have strata fields values above a set threshold for these characteristics.

Assignment engine 142 can use a point system to apply a comparative analysis between multiple sales representatives that have high performance indicators for these characteristics. Based on the number of points obtained by a sales representative, a cumulative score can be calculated and the lead can be assigned to the sales representative with the highest cumulative score. Such assignments can be stored in an assignment table 260 according to some implementations. In one implementation, assignment table 260 can include columns that specify assignments along with corresponding assignment IDs referred to as “ASN ID.” As shown in FIG. 2, table 260 can uniquely identify an assignment that identifies assigning of a lead named Prowess to Bob Jacob. This assignment can be give an assignment ID of “ASN2908.”

Assignment table 260 can have one or more of the following variables with certain attributes: COUNT_ID being CHAR (15 BYTE), USER_ID being CHAR (15 BYTE), ORGANIZATION_ID being CHAR (15 BYTE), CREATED_BY being CHAR (15 BYTE), CREATED_DATE being DATE, and DELETED being CHAR (1 BYTE). Assignment of prospects and accounts to various sales representatives can also be identified using assignment table 260.

### Flowchart for Performance Based Assignment

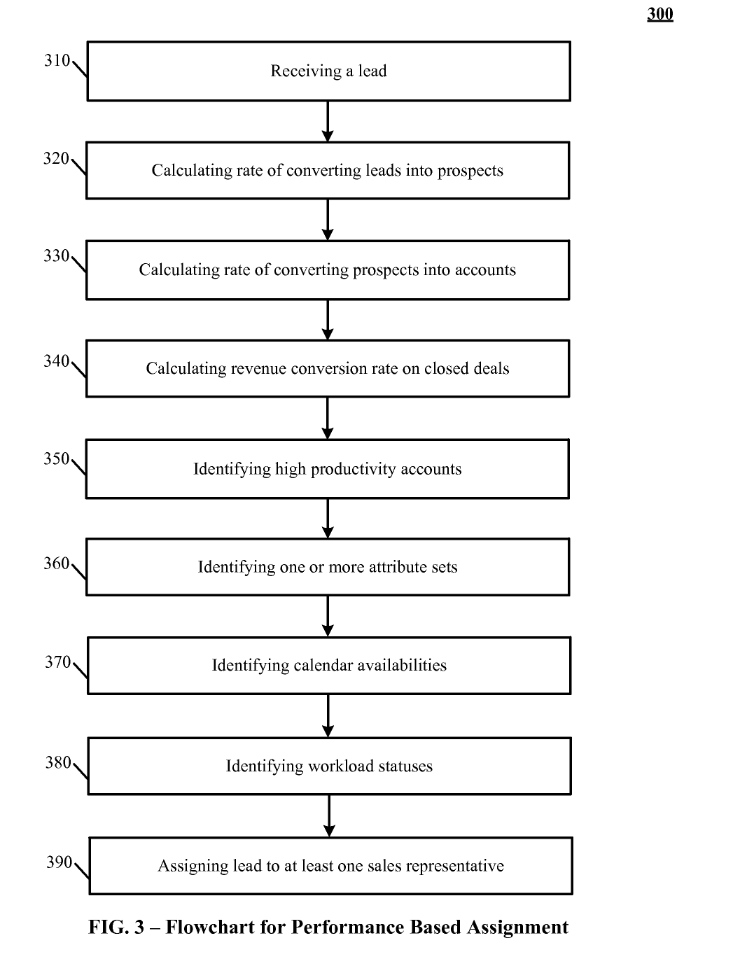

FIG. 3 is a flow chart 300 of one implementation for performance based assignment of sales opportunities. Other implementations may perform the steps in different orders and/or with different, fewer or additional steps than the ones illustrated in FIG. 3. Multiple steps can be combined in some implementations. For convenience, this flowchart is described with reference to the system that carries out a method. The system is not necessarily part of the method.

A lead that indicates interest of an organization in a product is received at step 310. Prospects and/or accounts can be also be received. In one implementation, an interest can be expressed via an in-person or online inquiry. In another implementation, service providers can use search engine optimization (SEO) to promote their websites or blogs and increase sales inquiries. This can attract attention of target leads, prospects and/or accounts that are seeking exact products or services.

Sales representatives' rate of converting leads into prospects can be calculated at step 320. This rate indicates what percentage of leads assigned to a particular sales representatives advanced into prospects and can be referred to as “qualification rate.” Qualification rates can be stratified by industry types, market segments, customer segments, employee sizes, product lines, service types, stock rates, locations, and territories. In another implementation, the following formula can be used to calculate the qualification rate of a sales representative:

Qualification Rate=[Total Number of Prospects/Total Number of Leads]*100

Sales representatives' rate of converting prospects into accounts can be calculated at step 330. This can be referred to as “closing rate” and can represent what percentage of prospects assigned to or advanced by a particular sales representatives got converted into accounts. Closing rates can be stratified by industry types, market segments, customer segments, employee sizes, product lines, service types, stock rates, locations, and territories. In another implementation, the following formula can be used to calculate the closing rate of a sales representative:

Closing Rate=[Total Number of Accounts/Total Number of Prospects]*100

Sales representatives' revenue conversion rate of closed deals are calculated at step 340. In one implementation, the average dollar amount brought in by each sales contract secured by a particular sales representative, which can referred to as “revenue conversion rate.” This rate can be normalized by eliminating very high and low values that skew the average. Revenue conversion rates can be stratified by industry types, market segments, customer segments, employee sizes, product lines, service types, stock rates, locations, and territories. In another implementation, the following formula can be used to calculate the revenue conversion rate of a sales representative:

Revenue Conversion Rate=[Total Revenue/Total Number of Accounts]

At step 350, high productivity accounts can be identified for which a particular sales representative's revenue conversion rate exceeds a threshold according to some implementations. For instance, all accounts of a particular sales representative that have a revenue conversion above a pre-set threshold of 89% can be automatically selected. High productivity accounts can be identified based on other indicators and ratios such as high workloads, high sale volumes, high impact, etc.

At step 360, one or more attribute sets of the high productivity accounts for the particular sales representative can be automatically identified. The attribute sets include at least employee size of the accounts and product lines purchased by the accounts. Finally, leads that possess attributes in the identified attribute sets can be assigned to the particular sales representative. For instance, if a sales representative has high performance ratios for accounts with an employee size less than 25, then leads with similar employee size can be assigned to the sales representative.

At step 370, assignment of sales opportunities can be balanced among a plurality of sales representatives by taking into account their calendar availabilities. This can be referred to as “calendar-based assignment.” In one implementation, identification of available slots in a sales representative's calendar during a required window of time can take place. In another implementation, the sales representative's commitment to other sale opportunities can be identified based on scheduling entries made in a calendar application or service running on a user device.

Sales opportunities such as leads, prospects and/or accounts can be evenly distributed between a plurality of sales representatives at step 380 by specifying the maximum amount of sales opportunities that can be assigned to a sales representative. This can be referred to as “workload-based assignment.” Thus, when a sales representative reaches an upper limit of workload, he may not be assigned any new sales opportunities. In yet other implementations, the upper limits can be specific to a sales representative based on his target, goals, responsibilities, and/or functions.

A forecast of the amount of work required to cover a target sales opportunity can be made and this estimate can be divided by the workload an average sales representative can handle. In this implementation, leads, prospects and/or accounts can be classified based on an estimate of amount of work required to service the target sales opportunity. In another implementation, this estimate can be based on past sales volumes.

Length of various steps of a sales cycle associated with a deal can be determined and the total amount of sales effort required to serve the entire market can be calculated. Then the time available per sales representative can be estimated and the time available per sales representative can be allocated based on the sales representative's responsibilities and functions. The following formula can be used to calculate the workload of a sales representative:

Workload=[Current accounts*Average time to service an active account]+[Prospects*Time spent trying to convert a prospect into an active account]+[Leads*Time spent trying to convert a lead into a prospect]

At step 390, a lead can be assigned to at least one sales representative based on one or more performance indicators and ratios. Certain characteristics of a lead can be identified so as to find sales representatives who are successful with accounts that share the same lead characteristics. Sales representatives that have strata fields values above a set threshold for these characteristics can be identified. In some other implementations, a point system can be used to apply a comparative analysis between multiple sales representatives that have high performance indicators for these characteristics. Based on the number of points obtained by a sales representative, a cumulative score can be calculated and the lead can be assigned to the sales representative with the highest cumulative score.

### Insight Based Assignment Records

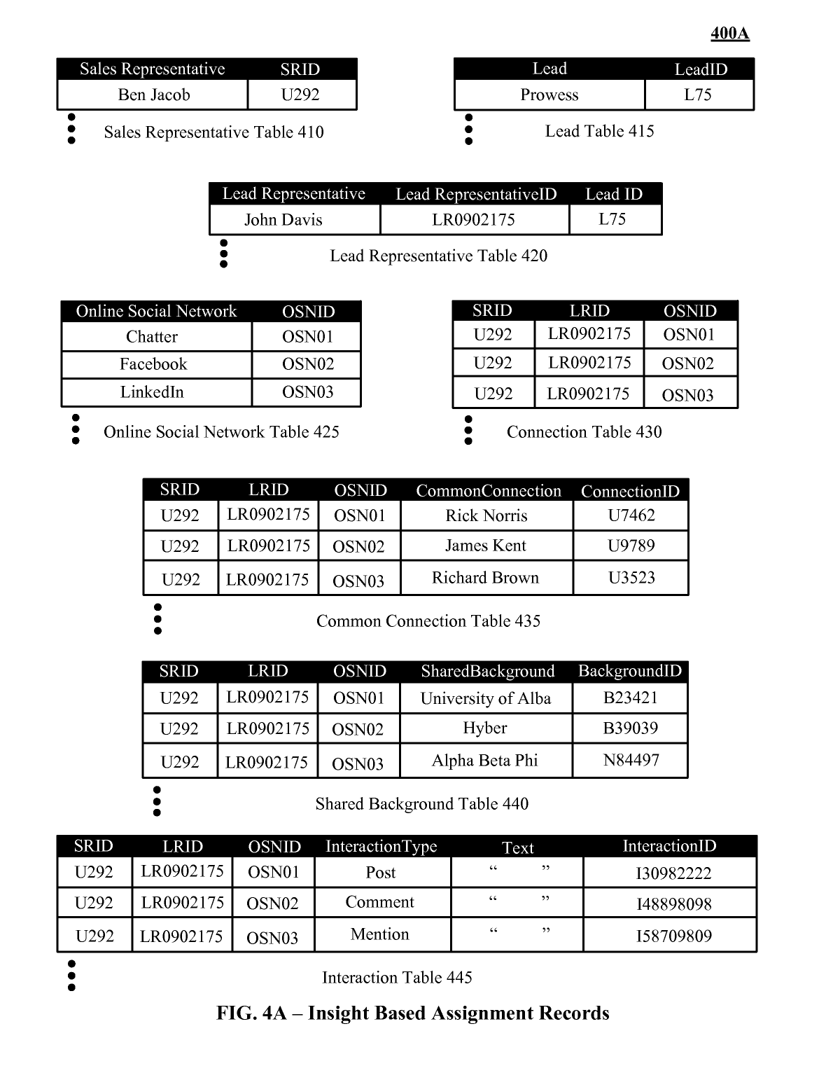

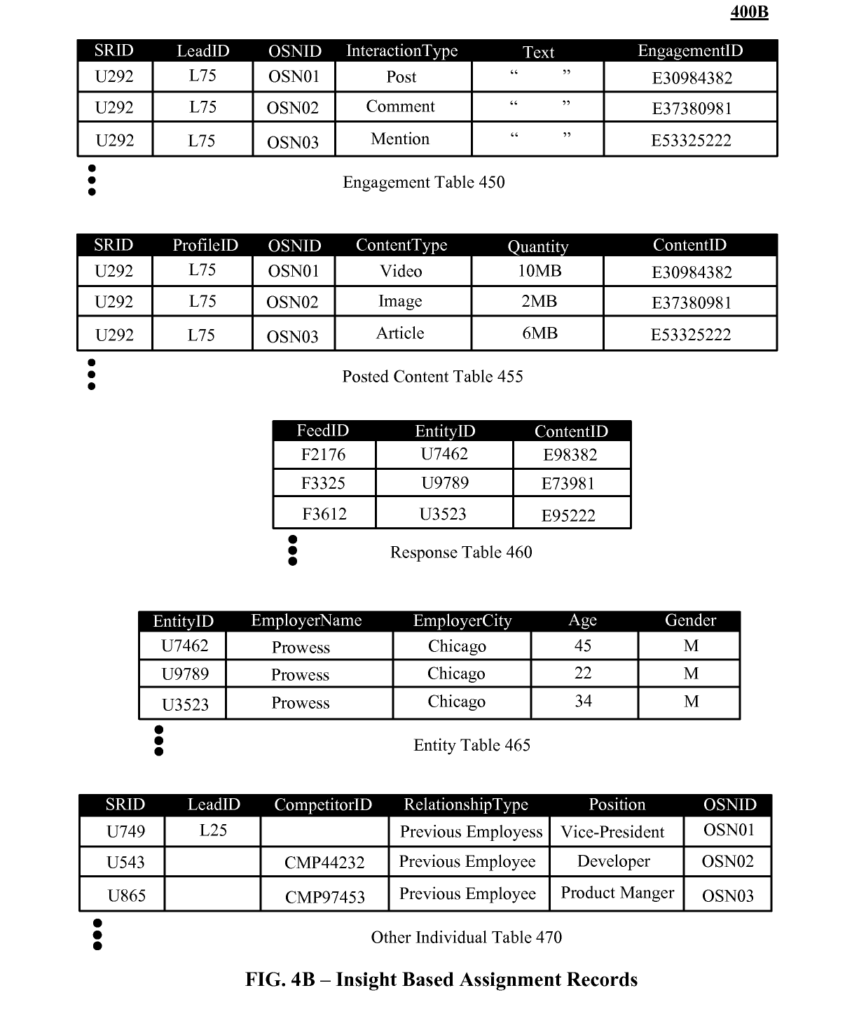

FIGS. 4A-4B show one implementation 400A-B of a plurality of tables that can be used for insight based assignment. As described above, this and other data structure descriptions that are expressed in terms of tables also can be implemented as objects or in tables that store multiple record or object types. Reference to tables is for convenience of explanation and not as a limitation on the data structure implementation.

FIG. 4A shows a sales representative table 410, lead table 415, lead representative table 420, online social network table 425, connection table 430, common connection table 435, shared background table 440, and interaction table 445. FIG. 4B can include an engagement table 450, posted content table 455, response table 460, entity table 465, and other individual table 470. Implementation 400 may not have the same tables, entries or fields as those listed above and/or may have other/different tables, entries or fields instead of, or in addition to, those listed above.

Sales representative table 410 can provide a list of sales representatives working for a service provider. It can include columns that specify names of sales representatives along with their sales representative IDs referred to as “SRID.” As shown in FIG. 4, table 410 can uniquely identify a sales representative with the name “Ben Jacob” and assign him a SRID of “U292.”

Sales representative table 410 can have one or more of the following variables with certain attributes: USER_ID being CHAR (15 BYTE), ORGANIZATION_ID being CHAR (15 BYTE), DEPARTMENT_ID being CHAR (15 BYTE), CREATED_BY being CHAR (15 BYTE), CREATED_DATE being DATE, and DELETED being CHAR (1 BYTE).

Each new entry can be added chronologically with a new record ID, which can be incremented in order. The first key prefix can provide a key that is unique to a group of records, e.g., custom records (objects). The “organization” variable can provide an ID of an organization to which the record is related. The “created by” variable can track the user who is performing the action that results in the record. The “created date” variable can specify the time stamp of record creation. The deleted variable can indicate that the record was deleted, and thus the record is not generated.

Lead table 415 can provide a list of leads that represent interests of organizations in products or services of a service provider. In one implementation, lead table 415 can include columns that specify names of leads along with their lead IDs referred to as “Lead ID.”

As shown in FIG. 4, table 415 can uniquely identify a lead as “Prowess” and assign it a LeadID of “L75.” Lead table 415 can have one or more of the following variables with certain attributes: ORGANIZATION_ID being CHAR (15 BYTE), SALES_REPRESENTATIVE_ID being CHAR (15 BYTE), CONTACT_ID being CHAR (15 BYTE), CREATED_BY being CHAR (15 BYTE), CREATED_DATE being DATE, and DELETED being CHAR (1 BYTE). Prospects and accounts tables that include various prospects and accounts attributes can also be specified.

Lead representative table 420 can provide a list of individuals working for a lead. In one implementation, lead representative table 420 can include columns that specify names of lead representatives along with their lead representative IDs referred to as “Lead Representative ID.” In another implementation, it can also include a column that includes LeadIDs of leads to which the individuals belong. As shown in FIG. 4, table 415 can uniquely identify a lead representative named “John Davis” working for Prowess. It can also be assigned a lead representative ID of “LR0902175.”

Lead representative table 420 can have one or more of the following variables with certain attributes: USER_ID being CHAR (15 BYTE), ORGANIZATION_ID being CHAR (15 BYTE), SALES_REPRESENTATIVE_ID being CHAR (15 BYTE), CREATED_BY being CHAR (15 BYTE), CREATED_DATE being DATE, and DELETED being CHAR (1 BYTE).

Online social network table 425 can include various online social networks such as Chatter, Facebook, LinkedIn, MySpace, Pinterest, tumblr, Flickr, Klout, foursquare, reddit, etc. In one implementation, online social network table 425 can include columns that specify names of online social networks along with their online social network IDs referred to as “OSNID.” As shown in FIG. 4, table 425 can uniquely identify online social networks such as Chatter, Facebook and LinkedIn and assign them online social network IDs “OSN1”, “OSN2” and “OSN3.”

Online social network table 425 can have one or more of the following variables with certain attributes: SOURCE_ID being CHAR (15 BYTE), ORGANIZATION_ID being CHAR (15 BYTE), USER_ID being CHAR (15 BYTE), CREATED_BY being CHAR (15 BYTE), CREATED_DATE being DATE, and DELETED being CHAR (1 BYTE).

Online social network table 425 can include various online social networks such as Chatter, Facebook, LinkedIn, MySpace, Pinterest, tumblr, Flickr, Klout, foursquare, reddit, etc. In one implementation, online social network table 425 can include columns that specify names of online social networks along with their online social network IDs referred to as “OSNID.” As shown in FIG. 4, table 425 can uniquely identify online social networks such as Chatter, Facebook and LinkedIn and assign them online social network IDs “OSN1”, “OSN2” and “OSN3.”

Online social network table 425 can have one or more of the following variables with certain attributes: SOURCE_ID being CHAR (15 BYTE), ORGANIZATION_ID being CHAR (15 BYTE), USER_ID being CHAR (15 BYTE), CREATED_BY being CHAR (15 BYTE), CREATED_DATE being DATE, and DELETED being CHAR (1 BYTE).

Connection table 430 can identify connections between sales representatives and lead representatives on various online social networks. In one implementation, it can specify which sales representative is connected to which lead representative on which online social network. In another implementation, connection table 430 can include columns that respectively use SRID and LRID to specify sales representatives and the lead representatives in the sales representatives' online social networks. It can also identify the online social networks on which the connections exist using OSNID.

As shown in FIG. 4, table 430 can uniquely identify that sales representative Bon Jacob is connected to lead representative John Davis on multiple online social networks including Chatter, Facebook and LinkedIn. Connection table 430 can have one or more of the following variables with certain attributes: FIRST_USER_ID being CHAR (15 BYTE), SECOND_USER_ID being CHAR (15 BYTE), SOURCE_ID being CHAR (15 BYTE), CREATED_BY being CHAR (15 BYTE), CREATED_DATE being DATE, and DELETED being CHAR (1 BYTE).

Common connection table 435 can identify common connections between sales representatives and lead representatives on various online social networks. In one implementation, common connection table 435 can include a column that specifies names of individuals that are connected to both sale representatives and lead representatives. It can also assign IDs to the common connections, which can be referred to as “ConnectionID.” It can also identify the online social networks on which the common connections exist using OSNID and can further use SRID and LRID to specify the sales representatives and lead representatives to whom the individuals are commonly connected.

As shown in FIG. 4, table 435 can uniquely identify that sales representative Bon Jacob and lead representative John Davis are connected to Rick Norris, James Kent and Richard on Chatter, Facebook and LinkedIn respectively. Common connection table 435 can have one or more of the following variables with certain attributes: USER ID being CHAR (15 BYTE), FIRST_USER_ID being CHAR (15 BYTE), SECOND_USER_ID being CHAR (15 BYTE), SOURCE_ID being CHAR (15 BYTE), CREATED_BY being CHAR (15 BYTE), CREATED_DATE being DATE, and DELETED being CHAR (1 BYTE).

Shared background table 440 can identify backgrounds shared between sales representatives and lead representatives. Examples of shared backgrounds can include same alma maters, previous employees, college fraternities, and the like. In one implementation, shared background table 440 can include a column that specifies types of backgrounds that are shared between the sale representatives and lead representatives. It can also assign IDs to the shared backgrounds, which can be referred to as “BackgroundID.” It can also identify the online social networks on which the shared backgrounds are specified using OSNID and can further use SRID and LRID to specify the sales representatives and lead representatives that share the backgrounds.

As shown in FIG. 4, table 440 can uniquely identify that sales representative Bon Jacob and lead representative John Davis have specified the same alma mater, University of Alba, on their Chatter accounts. Similarly, it can also identify, based on their Facebook profiles, that they have the same previous employee called Hyber. It can further specify that they belong to the same college fraternity, Alpha Beta Phi, based on their LinkedIn profiles.

Shared background table 440 can have one or more of the following variables with certain attributes: EVENT_ID being CHAR (15 BYTE), FIRST_USER_ID being CHAR (15 BYTE), SECOND_USER_ID being CHAR (15 BYTE), SOURCE_ID being CHAR (15 BYTE), CREATED_BY being CHAR (15 BYTE), CREATED_DATE being DATE, and DELETED being CHAR (1 BYTE).

Interaction table 445 can include various interactions between sales representatives and lead representatives on different online social networks. Examples of interactions can include comments, replies, posts, shares, mentions, and the like exchanged between the social profiles of the sales representatives and lead representatives.

In one implementation, interaction table 445 can include columns that specify types of interactions that occurred between the sale representatives and lead representatives along with their texts. It can further assign IDs to the interactions, which can be referred to as “InteractionID.” It can also identify the online social networks on which the interactions occurred using OSNID and can further can use SRID and LRID to specify the sales representatives and lead representatives that interacted.

As shown in FIG. 4, table 445 can uniquely identify that sales representative Bon Jacob and lead representative John Davis have interacted via a post, comment and mention on Chatter, Facebook and LinkedIn respectively. Interaction table 445 can have one or more of the following variables with certain attributes: EVENT_ID being CHAR (15 BYTE), FIRST_USER_ID being CHAR (15 BYTE), SECOND_USER_ID being CHAR (15 BYTE), SOURCE_ID being CHAR (15 BYTE), CREATED_BY being CHAR (15 BYTE), CREATED_DATE being DATE, and DELETED being CHAR (1 BYTE).

Engagement table 450 can specify various engagements between sales representatives and leads on different online social networks. Examples of engagements can include comments, replies, posts, shares, mentions, and the like exchanged between the social profiles of sales representatives and group profiles of leads. In one implementation, engagement table 450 can include columns that specify types of engagements that occurred between the sale representatives and leads along with their texts. It can further assign IDs to the engagements, which can be referred to as “EngagementID.” It can also identify the online social networks on which the engagements occurred using OSNID and can further use SRID and LRID to specify the sales representatives and leads that engaged.

As shown in FIG. 4, table 450 can uniquely identify that sales representative Bon Jacob and lead named Prowess have engaged via a post, comment and mention on Chatter, Facebook and LinkedIn respectively. Engagement table 450 can have one or more of the following variables with certain attributes: EVENT_ID being CHAR (15 BYTE), FIRST_USER_ID being CHAR (15 BYTE), SECOND_USER_ID being CHAR (15 BYTE), SOURCE_ID being CHAR (15 BYTE), CREATED_BY being CHAR (15 BYTE), CREATED_DATE being DATE, and DELETED being CHAR (1 BYTE).

Posted content table 455 can track the types and amounts of lead-related content posted by sales representatives on various online social networks. Relation to a lead can be identified based on lead's mentions in feed items, lead's tagging in feed items, postings of feed items on lead's social group account, and various other natural language processes. Examples of content types can include videos, images, articles, etc., which can be downloaded from various online social networks and their quantities can be identified based on the amount of memory storage consumed.

In one implementation, posted content table 455 can include columns that specify types of content shared by the sales representatives. It can further assign IDs to content postings, which can be referred to as “ContentID.” It can use a “ProfileID” to identify the leads to which the shared content is related to. It can also identify the online social networks on which the content was shared using OSNID and can further use SRID to specify the sales representative that shared the content.

As shown in FIG. 4, table 455 can uniquely identify that sales representative Bon Jacob shared a video of 10 MB, an image of 2 MB and an article of 6 MB related lead named Prowess on Chatter, Facebook and LinkedIn respectively. Posted content table 455 can have one or more of the following variables with certain attributes: COUNT_ID being CHAR (15 BYTE), TYPE_ID being CHAR (15 BYTE), FIRST_USER_ID being CHAR (15 BYTE), SOURCE_ID being CHAR (15 BYTE), CREATED_BY being CHAR (15 BYTE), CREATED_DATE being DATE, and DELETED being CHAR (1 BYTE).

Response table 460 can provide a list of entities (users and groups) that have responded to postings of feed items holding lead-related content. Examples of responses can include comments, replies, posts, shares, mentions, and the like posted by the entities. In one implementation, response table 460 can include columns that specify entities using “EntityID” and feed items using “FeedID.” It can also track the responses by “ContentID.”

As shown in FIG. 4, table 460 can uniquely identify that entities with EntityID “U7462”, “U9789” and “U3523” responded to postings of feed items with FeedID “U2176”, “U3325” and “F3612.” Response table 460 can have one or more of the following variables with certain attributes: EVENT_ID being CHAR (15 BYTE), FIRST_USER_ID being CHAR (15 BYTE), PARENT_ID being CHAR (15 BYTE), SOURCE_ID being CHAR (15 BYTE), CREATED_BY being CHAR (15 BYTE), CREATED_DATE being DATE, and DELETED being CHAR (1 BYTE).

As shown in FIG. 4, table 455 can uniquely identify that sales representative Bon Jacob shared a video of 10 MB, an image of 2 MB and an article of 6 MB related lead named Prowess on Chatter, Facebook and LinkedIn respectively. Posted content table 455 can have one or more of the following variables with certain attributes: COUNT_ID being CHAR (15 BYTE), TYPE_ID being CHAR (15 BYTE), FIRST_USER_ID being CHAR (15 BYTE), SOURCE_ID being CHAR (15 BYTE), CREATED_BY being CHAR (15 BYTE), CREATED_DATE being DATE, and DELETED being CHAR (1 BYTE).

Entity table 465 can provide a list of attributes of entities (users and groups) that have responded to postings of feed items holding lead-related content. Examples of attributes can include employer names, employer locations, poster ages, poster gender, and the like. As shown in FIG. 4, table 465 can uniquely identify that entities with EntityID “U7462”, “U9789” and “U3523” work for a Chicago based company named Prowess and further that they are males with ages 45, 22 and 34 respectively.

Entity table 465 can have one or more of the following variables with certain attributes: USER_ID being CHAR (15 BYTE), PROFESSIONAL_ATTRIBUTE_ID being CHAR (15 BYTE), PERSONAL_ATTRIBUTE_ID being CHAR (15 BYTE), SOURCE_ID being CHAR (15 BYTE), CREATED_BY being CHAR (15 BYTE), CREATED_DATE being DATE, and DELETED being CHAR (1 BYTE).

Other individual table 470 can provide a list of individuals who are working for the same service provider as the sales representative and who have already established relationships with leads and/or with competitors seeking the same lead, prospect, account, and/or market share. As shown in FIG. 4, table 465 can uniquely identify that sales representative with SRID “U749” worked for lead with LeadID “L25” as a vice-president. Similarly, it can specify that sales representative with SRID “U543” worked for competitor with “CompetitorID” of “CMP44232” as a developer. Also, it shows that sales representative with SRID “U865” worked as a product manager for competitor CompetitorID of “CMP97453.”

Other individual table 470 can have one or more of the following variables with certain attributes: USER_ID being CHAR (15 BYTE), INTERNAL_ORGANIZATION_ID being CHAR (15 BYTE), EXTERNAL_ORGANIZATION_ID being CHAR (15 BYTE), TITLE_ID being CHAR (15 BYTE), SOURCE_ID being CHAR (15 BYTE), CREATED_BY being CHAR (15 BYTE), CREATED_DATE being DATE, and DELETED being CHAR (1 BYTE).

### Flowchart for Insight Based Assignment

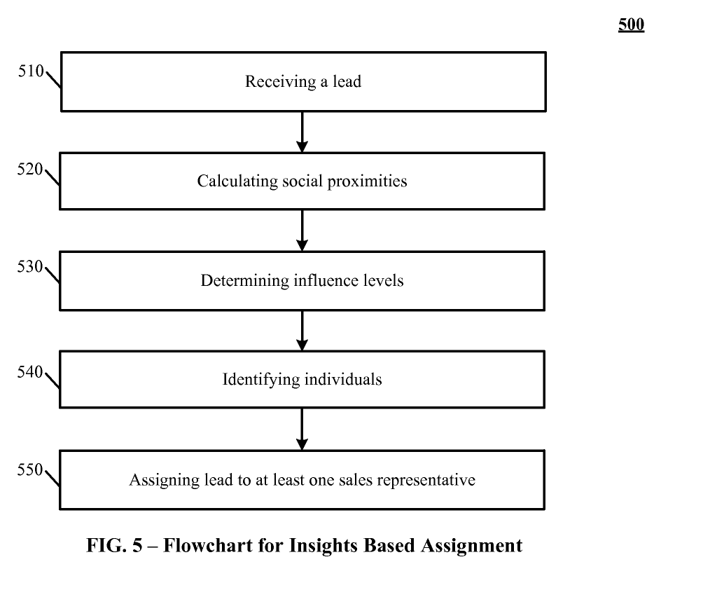

FIG. 5 is a flow chart 500 of one implementation for insight based assignment of sales opportunities. Other implementations may perform the steps in different orders and/or with different, fewer or additional steps than the ones illustrated in FIG. 5. Multiple steps can be combined in some implementations. For convenience, this flowchart is described with reference to the system that carries out a method. The system is not necessarily part of the method.

A lead that indicates interest of an organization in a product is received at step 510. Prospects and/or accounts can be also be received. In one implementation, an interest can be expressed via an in-person or online inquiry. In another implementation, service providers can use search engine optimization (SEO) to promote their websites or blogs and increase sales inquiries. This can attract attention of target leads, prospects and/or accounts that are seeking exact products or services.

At step 520, a plurality of social insights can be extracted from online social networks of the eligible sales representatives. These social insights can be indicative of sales representative's social proximities on the online social networks to leads, prospects and/or accounts and individuals belonging to the leads, prospects and/or accounts.

These social proximities can be calculated based on at least shared backgrounds between sales representatives and individuals belonging to the leads, prospects and/or accounts based on biographical information specified in their online social networks. These social proximities can be calculated based on connections, interactions and engagements on the online social networks between the sales representatives and individuals belonging to the leads, prospects and/or accounts.

At step 530, sales representatives' influence levels within the online social networks on the leads, prospects and/or accounts and individuals belonging to the leads, prospects and/or accounts can be calculated. Influence levels can be determined based on the number on connections a sales representative has with the individuals belonging to the leads, prospects and/or accounts. The influence levels can be determined based on at least quantities of lead-related content posted on the online social networks by the eligible sales representatives, number of feed items posted by other entities in the online social networks in response to the posting of lead-related content and attributes of the other entities that posted the feed items. Examples of attributes of the other entities that posted the feed items can include at least employer information, geographical origin, age, gender, etc.

Individuals in sales representative's extended sales team or organization who can help close a particular opportunity based on their relationships with prospects can be identified at step 540. Individuals in sales representative's extended sales team or organization who can help close a particular opportunity based on their relationships with competitors seeking to close the particular opportunity can be identified. The relationships of individuals in sales representative's extended sales team or organization with the prospects and with the competitors can be automatically identified based on biographical information specified in their online social networks.

At step 550, a lead can be assigned to at least one sales representative based on one or more social insights. Sales representatives' social proximities and influence levels with various online social networks can used for assignment of leads, prospects and/or accounts. Social proximity and influence levels can be calculated and sales representatives that have metric values above a set threshold can be selected. A point system can be used to apply a comparative analysis between multiple sales representatives that have same levels of proximities and influences. Based on the number of points obtained by a sales representative, a cumulative score can be calculated and the lead can be assigned to the sales representative with the highest cumulative score.

### Computer System

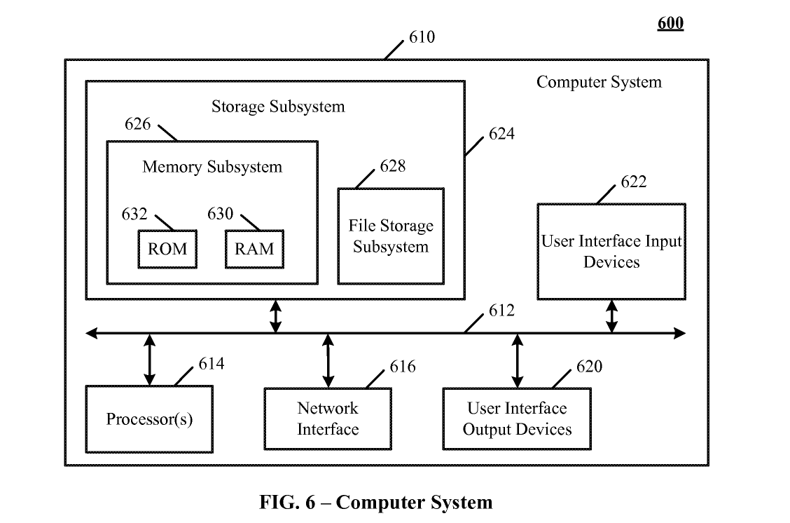

FIG. 6 is a block diagram of an example computer system 600 for feed customization and streamlining. FIG. 6 is a block diagram of an example computer system, according to one implementation. Computer system 610 typically includes at least one processor 614 that communicates with a number of peripheral devices via bus subsystem 612. These peripheral devices can include a storage subsystem 624 including, for example, memory devices and a file storage subsystem, user interface input devices 622, user interface output devices 620, and a network interface subsystem 616. The input and output devices allow user interaction with computer system 610. Network interface subsystem 616 provides an interface to outside networks, including an interface to corresponding interface devices in other computer systems.

User interface input devices 622 can include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include all possible types of devices and ways to input information into computer system 610.

User interface output devices 620 can include a display subsystem, a printer, a fax machine, or non-visual displays such as audio output devices. The display subsystem can include a cathode ray tube (CRT), a flat-panel device such as a liquid crystal display (LCD), a projection device, or some other mechanism for creating a visible image. The display subsystem can also provide a non-visual display such as audio output devices. In general, use of the term “output device” is intended to include all possible types of devices and ways to output information from computer system 610 to the user or to another machine or computer system.

Storage subsystem 624 stores programming and data constructs that provide the functionality of some or all of the modules and methods described herein. These software modules are generally executed by processor 614 alone or in combination with other processors.

Memory 626 used in the storage subsystem can include a number of memories including a main random access memory (RAM) 630 for storage of instructions and data during program execution and a read only memory (ROM) 632 in which fixed instructions are stored. A file storage subsystem 628 can provide persistent storage for program and data files, and can include a hard disk drive, a floppy disk drive along with associated removable media, a CD-ROM drive, an optical drive, or removable media cartridges. The modules implementing the functionality of certain implementations can be stored by file storage subsystem 628 in the storage subsystem 624, or in other machines accessible by the processor.

Bus subsystem 612 provides a mechanism for letting the various components and subsystems of computer system 610 communicate with each other as intended. Although bus subsystem 612 is shown schematically as a single bus, alternative implementations of the bus subsystem can use multiple busses.

Computer system 610 can be of varying types including a workstation, server, computing cluster, blade server, server farm, or any other data processing system or computing device. Due to the ever-changing nature of computers and networks, the description of computer system 610 depicted in FIG. 6 is intended only as one example. Many other configurations of computer system 610 are possible having more or fewer components than the computer system depicted in FIG. 6.

### Particular Implementations

In one implementation, a method is described from the perspective of a system receiving messages from a user software. The method includes effectively assigning opportunities to sales representatives. It includes automatically assigning the lead to at least one sales representative among eligible sales representatives by applying custom-target heuristics in response to receiving a lead that indicates interest of an organization in a product. It further includes the custom-target heuristics including a plurality of performance indicators of the eligible sales representatives.

This method and other implementations of the technology disclosed can each optionally include one or more of the following features and/or features described in connection with additional methods disclosed. In the interest of conciseness, the combinations of features disclosed in this application are not individually enumerated and are not repeated with each base set of features. The reader will understand how features identified in this section can readily be combined with sets of base features identified as implementations such as feed customization environment, event-based feed customization, target entity-based feed customization, feed posting entities-based feed customization, etc.

The method further includes the performance indicators being calculated from data that describe historical and ongoing sales processes. It includes the performance indicators including the eligible sales representatives' rate of converting leads into prospects. It also includes the eligible sales representatives' rate of converting leads into prospects being stratified by at least industry type, market segment and location.

The method further includes the performance indicators including the eligible sales representatives' rate of converting prospects into accounts. It also includes the eligible sales representatives' rate of converting prospects into accounts being stratified by at least industry type, market segment and location.

The method further includes the performance indicators including the eligible sales representatives' revenue conversion rate on closed deals. It includes identifying high productivity accounts for which a particular sales representative's revenue conversion rate exceeds a threshold, identifying one or more attribute sets of the high productivity accounts for the particular sales representative and assigning leads that possess attributes in the identified attribute sets to the particular sales representative. It also includes the attribute sets including at least employee size of the accounts and product lines purchased by the accounts.

The method further includes using an availability-based assignment for distributing sales opportunities among a plurality of sales representatives, wherein the availability-based assignment takes into account calendar availabilities of the sales representatives.

The method further includes using a workload-based assignment for distributing sales opportunities among a plurality of sales representatives, wherein the workload-based assignment specifies limits on maximum number of sales opportunities assigned to the sales representatives.

Other implementations may include a non-transitory computer readable storage medium storing instructions executable by a processor to perform any of the methods described above. Yet another implementation may include a system including memory and one or more processors operable to execute instructions, stored in the memory, to perform any of the methods described above.

In another implementation, a method is described from the perspective of a system receiving messages from a user software. The method includes effectively assigning opportunities to sales representatives. It includes automatically assigning the lead to at least one sales representative among eligible sales representatives by applying custom-target heuristics in response to receiving a lead that indicates interest of an organization in a product. It further includes the custom-target heuristics including a plurality of social insights extracted from online social networks of the eligible sales representatives.

This method and other implementations of the technology disclosed can each optionally include one or more of the following features and/or features described in connection with additional methods disclosed.

The method further includes the social insights being indicative of sales representative's social proximities on the online social networks to the organization and individuals belonging to the organization. In also includes calculating the social proximities calculated based on at least shared backgrounds between the eligible sales representatives and individuals belonging to the organization based on biographical information specified in their online social networks and connections, interactions and engagements on the online social networks between the eligible sales representatives and individuals belonging to the organization.

The method further includes the social insights including the eligible sales representatives' influence levels within the online social networks on the organization and individuals belonging to the organization. It includes determining the influence levels based on at least quantities of lead-related content posted on the online social networks by the eligible sales representatives, number of feed items posted by other entities in the online social networks in response to the posting of lead-related content and attributes of the other entities that posted the feed items. It also includes the attributes of the other entities that posted the feed items including at least employer information, geographical origin, age, and gender

The method further includes identifying individuals in sales representative's extended sales team who can help close a particular opportunity based on their relationships with prospects.

The method further includes identifying individuals in sales representative's extended sales team who can help close a particular opportunity based on their relationships with competitors seeking to close the particular opportunity.

The method further includes the relationships of individuals in sales representative's extended sales team with the prospects and with the competitors being automatically identified based on biographical information specified in their online social networks.

Other implementations may include a non-transitory computer readable storage medium storing instructions executable by a processor to perform any of the methods described above. Yet another implementation may include a system including memory and one or more processors operable to execute instructions, stored in the memory, to perform any of the methods described above.

While the present invention is disclosed by reference to the preferred implementations and examples detailed above, it is to be understood that these examples are intended in an illustrative rather than in a limiting sense. It is contemplated that modifications and combinations will readily occur to those skilled in the art, which modifications and combinations will be within the spirit of the invention and the scope of the following claims.

1. A method for effectively assigning opportunities to sales representatives, the method including:
in response to receiving a lead that indicates interest of an organization in a product, automatically assigning the lead to at least one sales representative among eligible sales representatives by applying custom-target heuristics; and
wherein the custom-target heuristics include a plurality of performance indicators of the eligible sales representatives.

2. The method of claim 1, wherein the performance indicators are calculated from data that describe historical and ongoing sales processes.

3. The method of claim 2, wherein the performance indicators include the eligible sales representatives' rate of converting leads into prospects.

4. The method of claim 3, wherein the eligible sales representatives' rate of converting leads into prospects are stratified by at least industry type, market segment and location.

5. The method of claim 2, wherein the performance indicators include the eligible sales representatives' rate of converting prospects into accounts.

6. The method of claim 5, wherein the eligible sales representatives' rate of converting prospects into accounts are stratified by at least industry type, market segment and location.

7. The method of claim 2, wherein the performance indicators include the eligible sales representatives' revenue conversion rate on closed deals.

8. The method of claim 7, further including
identifying high productivity accounts for which a particular sales representative's revenue conversion rate exceeds a threshold;
identifying one or more attribute sets of the high productivity accounts for the particular sales representative; and
assigning leads that possess attributes in the identified attribute sets to the particular sales representative.

9. The method of claim 8, wherein the attribute sets include at least employee size of the accounts and product lines purchased by the accounts.

10. The method of claim 1, further including using an availability-based assignment for distributing sales opportunities among a plurality of sales representatives, wherein the availability-based assignment takes into account calendar availabilities of the sales representatives.

11. The method of claim 1, further including using a workload-based assignment for distributing sales opportunities among a plurality of sales representatives, wherein the workload-based assignment specifies limits on maximum number of sales opportunities assigned to the sales representatives.

12. A method for effectively assigning opportunities to sales representatives, the method including:
in response to receiving a lead that indicates interest of an organization in a product, automatically assigning the lead to at least one sales representative among eligible sales representatives by applying custom-target heuristics; and
wherein the custom-target heuristics include a plurality of social insights extracted from online social networks of the eligible sales representatives.

13. The method of claim 12, wherein the social insights are indicative of sales representative's social proximities on the online social networks to the organization and individuals belonging to the organization.

14. The method of claim 13, wherein the social proximities are calculated based on at least:
shared backgrounds between the eligible sales representatives and individuals belonging to the organization based on biographical information specified in their online social networks; and
connections, interactions and engagements on the online social networks between the eligible sales representatives and individuals belonging to the organization.

15. The method of claim 12, wherein the social insights include the eligible sales representatives' influence levels within the online social networks on the organization and individuals belonging to the organization.

16. The method of claim 15, wherein the influence levels are determined based on at least:
quantities of lead-related content posted on the online social networks by the eligible sales representatives;
number of feed items posted by other entities in the online social networks in response to the posting of lead-related content; and
attributes of the other entities that posted the feed items.

17. The method of claim 16, wherein the attributes of the other entities that posted the feed items include at least employer information, geographical origin, age, and gender.

18. The method of claim 12, further including identifying individuals in sales representative's extended sales team who can help close a particular opportunity based on their relationships with prospects.

19. The method of claim 12, further including identifying individuals in sales representative's extended sales team who can help close a particular opportunity based on their relationships with competitors seeking to close the particular opportunity.

20. The method of claim 12, wherein the relationships of individuals in sales representative's extended sales team with the prospects and with the competitors are automatically identified based on biographical information specified in their online social networks.
